(19) United States
(12) Patent Application Publication
(10) Pub. No.: US 2011/0185775 A1
(43) Pub. Date: Aug. 4, 2011

(54) PADLOCKS WITH ANTI-RAPPING SECURITY FEATURES

(75) Inventors: Billy B. Edwards, JR., Brookfield, WI (US); Glenn P. Meekma, Menomonee Falls, WI (US)

(73) Assignee: MASTER LOCK COMPANY LLC, Oak Creek, WI (US)

(21) Appl. No.: 13/016,366

(22) Filed: Jan. 28, 2011

Related U.S. Application Data
(60) Provisional application No. 61/300,106, filed on Feb. 1, 2010.
(60) Provisional application No. 61/304,897, filed on Feb. 16, 2010.

(51) Int. Cl. E05B 37/02; E05B 67/06; E05B 67/02; E05B 37/00

(52) U.S. Cl. 70/24; 70/22

(57) ABSTRACT

A combination padlock includes a lock housing, a shackle, and a plurality of dials. A blocking member disposed within the lock housing is pivotable about a pivot point on the blocking member between a shackle securing position and a shackle releasing position. Each of the plurality of dials includes an unlocking feature disposed on an outer periphery of the dial. When each of the plurality of dials is rotated to an unlocking orientation, each of the unlocking features aligns with a corresponding dial engaging portion of the blocking member, allowing the blocking member to pivot from the shackle securing position to the shackle releasing position. Engagement of the blocking member with the inner front surface of the lock housing is limited to a location longitudinally aligned with the pivot point to limit lateral movement of the blocking member without limiting pivoting movement of the blocking member.

### CROSS-REFERENCE TO RELATED APPLICATIONS

This application claims the benefit of U.S. Provisional Patent Application Ser. No. 61/300,106, entitled PADLOCKS WITH ANTI-RAPPING SECURITY FEATURES and filed Feb. 1, 2010, and U.S. Provisional Patent Application Ser. No. 61/304,879, entitled PADLOCKS WITH ANTI-RAPPING SECURITY FEATURES and filed Feb. 16, 2010, the entire disclosures of both of which are incorporated herein by reference.

### BACKGROUND

Padlocks are used in a variety of applications, including, for example, with enclosures such as lockers, storage sheds, and various gates and doors. A typical padlock includes a lock housing having a generally U-shaped shackle extending from one end and a lock interface (e.g., a keyway or one or more combination dials) disposed on the lock housing. The shackle is secured in the lock housing by one or more locking members held in locking engagement with the shackle by a blocking member. The typical padlock is unlocked by proper manipulation of the lock interface (e.g., rotation of a key cylinder using an inserted authorized key, or rotation of a combination dial or dials in accordance with an authorized combination code), which moves the blocking member out of engagement with the one or more locking members. This allows the one or more locking members to disengage from the shackle, thereby permitting axial movement of the shackle for separation of the shackle from the lock housing (i.e., withdrawal of at least one leg of the U-shaped shackle from the lock housing), for removal of the lock from a hasp or other such portion of a locked structure.

In one conventional padlock, the blocking member is pivotable from the locked condition to the unlocked condition upon proper manipulation of the lock interface.

### SUMMARY

The present application describes inventive arrangements for preventing unauthorized opening of a padlock through sliding movement of a pivotable blocking member in a padlock without proper manipulation of the lock interface, for example, by inserting a lock pick or other tool into the lock (e.g., through openings in the lock housing in which one or more combination dials are disposed) to push, rap, or otherwise move the blocking member out of engagement with the locking members. According to an inventive aspect of the present application, a pivotable blocking member may be laterally fixed or restricted at a location longitudinally aligned with a pivot point of the blocking member, such that lateral movement of the blocking member is limited without limiting pivoting movement of the blocking member.

Accordingly, in one embodiment, a combination padlock includes a lock housing, a shackle, and a plurality of dials. A blocking member disposed within the lock housing is pivotable about a pivot point on the blocking member between a shackle securing position and a shackle releasing position. Each of the plurality of dials includes an unlocking feature disposed on an outer periphery of the dial. When each of the plurality of dials is rotated to an unlocking orientation, each of the unlocking features aligns with a corresponding dial engaging portion of the blocking member, allowing the blocking member to pivot from the shackle securing position to the shackle releasing position. Engagement of the blocking member with the inner front surface of the lock housing is limited to a location longitudinally aligned with the pivot point to limit lateral movement of the blocking member without limiting pivoting movement of the blocking member.

### BRIEF DESCRIPTION OF THE DRAWINGS

Further features and advantages of the invention will become apparent from the following detailed description made with reference to the accompanying drawings, wherein:

FIG. 1 is perspective view of a conventional multiple dial combination padlock;

FIG. 2 is a front cross-sectional view of the conventional multiple dial combination padlock of FIG. 1, shown in a locked condition;

FIG. 3 is a side cross-sectional view of the conventional multiple dial combination padlock of FIG. 1, shown in an unlocked or shackle releasing condition;

FIG. 4 is a perspective view of the blocking member of the conventional multiple dial combination padlock of FIG. 1;

FIG. 5 is a partial side cross-sectional view of a multiple dial combination padlock having a blocking member with a rap-preventing feature;

FIG. 6 is a perspective view of the blocking member of the multiple dial combination padlock of FIG. 5; and

FIG. 7 is a partial side cross-sectional view of a multiple dial combination padlock having a lock housing with a rap preventing feature.

### DETAILED DESCRIPTION

This Detailed Description merely describes embodiments of the invention and is not intended to limit the scope of the claims in any way. Indeed, the invention as claimed is broader than and unlimited by the preferred embodiments, and the teens used in the claims have their full ordinary meaning.

In a conventional combination padlock having a multiple-dial locking arrangement, each combination dial includes an unlocking feature configured to receive a portion of a blocking member when the combination dial is in an unlocking orientation. When all of the combination dials are in the corresponding unlocking orientations, the blocker is movable into engagement with the unlocking portions of the dials, thereby allowing disengagement of the one or more locking members from the shackle to allow axial withdrawal of the shackle from the lock housing.

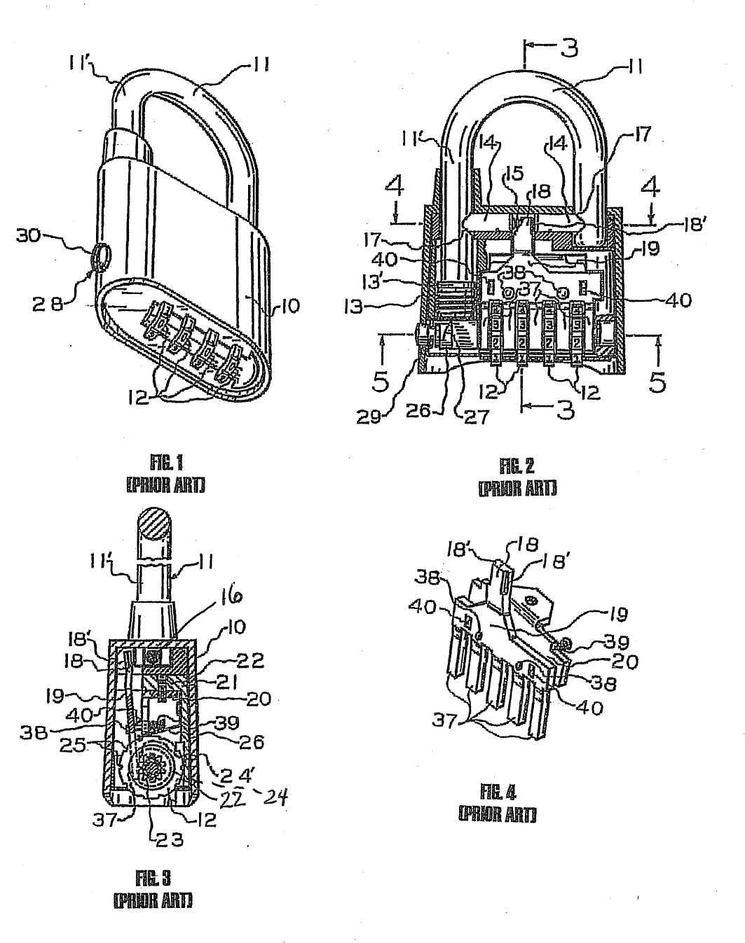

While many different multiple dial and blocker locking arrangements may be utilized, one such exemplary arrangement is described in U.S. Pat. No. 3,983,724 (the '724 Patent), the entire disclosure of which is incorporated by reference, to the extent that it does not conflict with the present application. As shown in FIGS. 1-3, the lock includes a lock housing 10 that retains a shackle 11 that is unlocked by rotation of the combination dials 12 (which include numbered wheels 22 and corresponding hubs 24) on shaft 23 to their unlocking orientations. In order to releasably lock the shackle 11 in its closed position of FIG. 2, a pair of oppositely disposed locking members 14 are provided which are operatively housed in an upper portion of lock housing 10. These bolts 14 are biased in opposite directions by a spring 15, retained on a pin 16, into aligned notches 17 in the legs of the shackle 11. The shackle locking members 14 are forced into locking engagement with the shackle notches 17 by the blocking finger portion 18 of a pivotable blocking member 19.

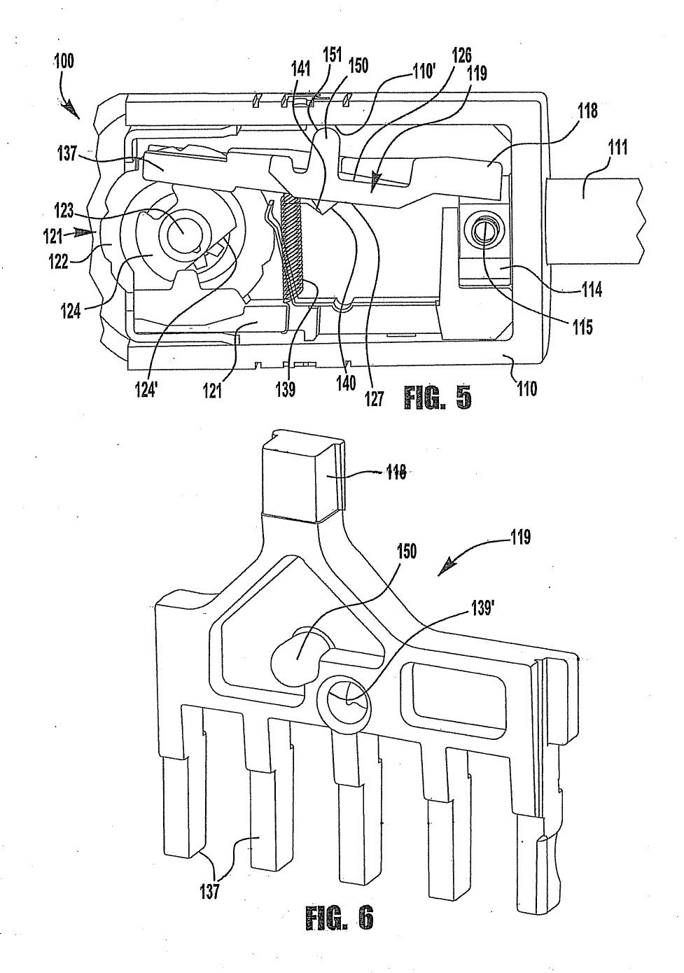

The blocking member 19, shown in detail in FIG. 4, includes a series of spaced-apart dial engaging fingers 37 projecting downwardly from its main intermediate portion in a direction opposite the blocking finger 18. Springs 39 are secured to the blocking member 19 to cause the blocking member to be pulled from its nominal locked position of FIG. 2 to its unlocked or locking member releasing position of FIG. 3. The blocking member moves from the locked position to the unlocked position by rocking or pivoting on a pair of pivot protuberances 40 extending from the blocking member 19 and contactable with corresponding pivot bearing portions of the lock housing.

When the shackle 11 is retracted and locked, the hub engaging fingers 37 are forced outward by the outer peripheries of the hubs 24. To unlock the shackle 11, the hubs 24 are properly positioned by manually turning their respective wheels 22 to the assigned combination, at which flatted unlocking features 24′ of the hubs 24 align with the hub engaging fingers 37 to allow the blocking member 19 to pivot on the protuberances 40 to the unlocked position of FIG. 3. Upon pivoting of the blocking member 19, the blocking finger 18 is pivoted out of engagement with the locking members 14, allowing the locking members 14 to retract out of engagement with the shackle notches 17 when the shackle 11 is pulled.

While the pivotable blocking member 19 is restricted from pivotable movement by engagement with the outer peripheries of the hubs 24, the blocking member 19 may be susceptible to lateral movement or shifting, such that the blocking finger 18 is laterally shifted out of engagement with the locking members 14. This lateral shifting of the blocking member 19, in an unauthorized attempt to open the padlock, may be accomplished by insertion of a lock pick or other instrument into the lock housing 10 (e.g., through one of the openings in the lock housing through which the dials 12 protrude), thereby rapping or forcing the blocking member 19 laterally outward to disengage the blocking finger 18 from the locking members 14.

According to an inventive aspect of the present application, a multiple dial combination padlock with a pivotable blocking member may be adapted to prevent lateral sliding movement of the blocking member to disengage a blocking finger from shackle engaging locking members. In one embodiment, the lock may be adapted such that the blocking member is substantially laterally restricted while being freely pivotable about pivot protrusions extending from the blocking member. In one such embodiment (not shown), the blocking member may be laterally fixed to the lock housing, for example, by a pivot pin securing the blocking member to the lock housing while allowing the blocking member to pivot. In another embodiment, the blocking member may be laterally engageable with an inner surface of the lock housing at a location substantially aligned with the pivot point of the blocking member, such that lateral engagement between the lock housing and blocking member does not impede pivotable movement of the blocking member (i.e., does not produce a pivotable limit position), but substantially limits or prevents lateral shifting movement of the blocking member within the lock housing.

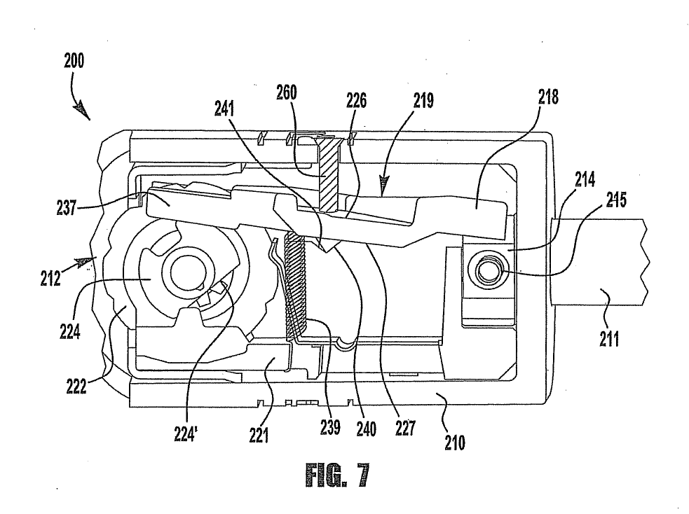

FIG. 5 illustrates a side cross-sectional view of a padlock 100 adapted to prevent lateral rapping of the blocking member 119 out of engagement with the locking members 114, according to an inventive aspect of the present application. Lock components not visible in the view of FIG. 5 may, but need not be, comparable to, consistent with, or even substantially identical to, the corresponding components of the padlock of FIGS. 1-3, and may function substantially similarly to the padlock of FIGS. 1-3. As shown, the exemplary blocking member 119 includes a stabilizing protrusion 150 extending from a housing facing surface 126 of the blocking member. The stabilizing protrusion 150 is substantially aligned with one or more pivot protrusions 140 extending from an insert facing surface 127 of the blocking member 119 opposite the housing facing surface 126. The blocking member 119 is free to pivot about the pivot protrusions 140 against corresponding pivot bearing surfaces 141 in a housing insert 121 within the lock housing 110 when the dials 112 and hubs 124 are rotated to their unlocking orientations. While the stabilizing protrusion 150 may engage the adjacent inner front surface 110′ of the housing 110, the lock 100 may alternatively be configured to provide a small gap between the protrusion 150 and the housing inner front surface 110′ to further ensure that pivotable movement of the blocking member 119 is not impeded by the protrusion 150. Additionally, the stabilizing protrusion 150 may be provided with a rounded end portion 151 to further facilitate pivotable movement of the blocking member 119.

When the padlock 100 is in the locked condition (as shown in FIG. 5), any attempt to laterally shift the blocking member 119 to disengage the blocking finger 118 from the locking members 114 will result in the protrusion 150 abutting the housing inner front surface 110′, thereby preventing further lateral movement of the blocking member 119 to retain the blocking finger 118 in blocking engagement with the locking members 114. In this shifted position, the protrusion 150 and the outermost hub engaging fingers 137 of the blocking member 119 act as three legs of a tripod to anchor the blocking member 119 against lateral movement. When the combination dials 112 are each rotated about shaft 123 to the unlocking orientation, alignment of the flatted unlocking features 124′ of the hubs 124 with the hub engaging fingers 137 of the blocking member 119 allows the blocking member 119 to be pivoted by spring 139 (secured between the lock housing 110 and a spring anchoring hole 139′ in the blocking member 219, see FIG. 6) for disengagement of the blocking finger 118 from the locking members 114.

The exemplary blocking member 119 is shown in greater detail in FIG. 6. While the stabilizing protrusion 150 is shown as being integral with the blocking member 119 (e.g., as a die-cast or molded feature), the protrusion may alternatively be assembled with the blocking member. As one example (not shown), a roll pin may be press fit through a hole in the blocking member to provide the stabilizing protrusion. As another example, a machine screw, set screw, or other such fastener may be threadably assembled with the blocking member to provide the stabilizing protrusion.

In another inventive embodiment, a padlock may include a lock housing having an inward protrusion substantially aligned with a pivot point of the pivotable blocking member, to substantially limit or prevent lateral shifting movement of the blocking member without impeding pivotable movement of the blocking member (i.e., without producing a pivotable limit position). In the exemplary embodiment of FIG. 7, a padlock 200 includes a lock housing 210 that includes an inward projecting stabilizing protrusion 260 (e.g., an projection, pressed pin, or threaded fastener, as shown) substantially aligned with pivot protrusions 240 of the blocking member 219. This alignment allows the blocking member 219 is to pivot freely against corresponding pivot bearing surfaces 241 in a housing insert 221 within the lock housing 210 when the dials 212 are rotated to their unlocking orientations. While the stabilizing protrusion 260 may engage the adjacent housing facing surface 226 of the blocking member 219 (i.e., the surface opposite insert facing surface 227 and pivot protrusions 240), the lock 200 may alternatively be configured to provide a small gap between the protrusion 260 and the housing facing surface 226 to further ensure that pivotable movement of the blocking member 219 is not impeded by the protrusion 260.

When the padlock 200 is in the locked condition (as shown in FIG. 7), any attempt to laterally shift the blocking member 219 to disengage the blocking finger 218 from the locking members 214 will result in the protrusion 260 abutting the housing facing surface 226, thereby preventing further lateral movement of the blocking member 219 to retain the blocking finger 218 in blocking engagement with the locking members 214. When the combination dials 212 and hubs 224 are each rotated about shaft 223 to the unlocking orientation, alignment of the flatted unlocking features 224′ of the hubs 224 with the hub engaging fingers 237 of the blocking member 219 allows the blocking member 219 to be pivoted by spring 239 (secured between the lock housing 210 and the blocking member) for disengagement of the blocking finger 218 from the locking members 214.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

We claim:

1. A combination padlock comprising:
a lock housing;
a shackle secured within the lock housing when the lock is in a locked condition and separable from the lock housing when the lock is in an unlocked condition;
a blocking member disposed within the lock housing and including a housing facing surface adjacent an inner front surface of the lock housing, the blocking member being pivotable about a pivot point on the blocking member between a shackle securing position, in which the blocking member forces at least one locking member into locking engagement with the shackle, and a shackle releasing position, in which the blocking member allows the at least one locking member to disengage from the shackle for separation of the shackle from the lock housing; and
a plurality of dials, each of the plurality of dials including an unlocking feature disposed on an outer periphery of the dial, wherein when each of the plurality of dials is rotated to an unlocking orientation, each of the unlocking features aligns with a corresponding dial engaging portion of the blocking member, allowing the blocking member to pivot from the shackle securing position to the shackle releasing position;
wherein engagement of the blocking member with the inner front surface of the lock housing is limited to a location longitudinally aligned with the pivot point to limit lateral movement of the blocking member without limiting pivoting movement of the blocking member.

2. The padlock of claim 1, wherein the blocking member includes a protrusion longitudinally aligned with the pivot point and extending toward the inner front surface of the lock housing to limit lateral movement of the blocking member.

3. The padlock of claim 2, wherein the protrusion is integral to the housing facing surface of the blocking member.

4. The padlock of claim 2, wherein the protrusion comprises a fastener assembled with the housing facing surface of the blocking member.

5. The padlock of claim 1, wherein the lock housing includes a protrusion extending from the inner front surface toward the housing facing surface of the blocking member.

6. The padlock of claim 5, wherein the protrusion is integral to the inner front surface of the lock housing.

7. The padlock of claim 5, wherein the protrusion comprises a fastener assembled with the housing facing surface of the blocking member.

8. The padlock of claim 1, wherein a gap is provided between the lock housing and the blocking member at the location longitudinally aligned with the pivot point.

9. The padlock of claim 1, wherein when the blocking member is shifted laterally toward the inner front surface of the lock housing, the blocking member abuts the housing at a location longitudinally aligned with the pivot point to prevent disengagement of the blocking member from the at least one locking member.

10. A blocking member for a combination padlock, the blocking member comprising:
a main body having a longitudinally extending housing facing surface and a longitudinally extending insert facing surface opposite the housing facing surface;
a blocking finger extending longitudinally from a first end of the main body;
a plurality of dial engaging fingers extending longitudinally from a second end of the main body opposite the first end;
a pivot protrusion extending laterally from the insert facing surface; and
a stabilizing protrusion extending laterally from the housing facing surface, the stabilizing protrusion being longitudinally aligned with the pivot protrusion.

11. The blocking member of claim 10, wherein the stabilizing protrusion is integral with the main body.

12. The blocking member of claim 10, wherein the stabilizing protrusion comprises a fastener assembled with the main body.

13. A combination padlock comprising:
a lock housing;
a shackle secured within the lock housing when the lock is in a locked condition and separable from the lock housing when the lock is in an unlocked condition;
a blocking member disposed within the lock housing and including:
a main body having a longitudinally extending housing facing surface adjacent an inner front surface of the lock housing and a longitudinally extending insert facing surface opposite the housing facing surface;
a blocking finger extending longitudinally from a first end of the main body;
a plurality of dial engaging fingers extending longitudinally from a second end of the main body opposite the first end;
a pivot protrusion extending laterally from the insert facing surface; and
a stabilizing protrusion extending laterally from the housing facing surface, the stabilizing protrusion being longitudinally aligned with the pivot protrusion;
wherein the blocking member is pivotable about the pivot protrusion between a shackle securing position, in which the blocking finger forces at least one locking member into locking engagement with the shackle, and a shackle releasing position, in which the blocking finger allows the at least one locking member to disengage from the shackle for separation of the shackle from the lock housing; and
a plurality of dials, each of the plurality of dials including an unlocking feature disposed on an outer periphery of the dial, wherein when each of the plurality of dials is rotated to an unlocking orientation, each of the unlocking features aligns with a corresponding dial engaging portion of the blocking member, allowing the blocking member to pivot from the shackle securing position to the shackle releasing position;
wherein when the blocking member is shifted laterally toward the inner front surface of the lock housing, the stabilizing protrusion abuts the inner front surface of the lock housing to prevent disengagement of the blocking member from the at least one locking member.

14. The padlock of claim 13, wherein the stabilizing protrusion is integral to the housing facing surface of the blocking member.

15. The padlock of claim 13, wherein the stabilizing protrusion comprises a fastener assembled with the housing facing surface of the blocking member.

16. The padlock of claim 13, wherein a gap is provided between the lock housing and the stabilizing protrusion.

17. The padlock of claim 13, wherein when the blocking member is shifted laterally toward the inner front surface of the lock housing, the stabilizing protrusion abuts the housing at a location longitudinally aligned with the pivot point to prevent disengagement of the blocking member from the at least one locking member.
